(19) United States
(12) Patent Application Publication
(10) Pub. No.: US 2010/0042397 A1
(43) Pub. Date: Feb. 18, 2010

(54) DATA PROCESSING APPARATUS AND METHOD

(75) Inventor: Kensuke MASUGATA, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi (JP)

(21) Appl. No.: 12/540,730

(22) Filed: Aug. 13, 2009

(30) Foreign Application Priority Data
Aug. 14, 2008 (JP) 2008-208916

(51) Int. Cl. G06F 17/28

(52) U.S. Cl. 704/2

(57) ABSTRACT

A data analyzing apparatus is provided with: a first weight memory unit for storing a weight assigned to a node or an edge in a directed graph; a second weight memory unit for storing a weight different from the weight stored in the first weight memory unit when the different weight is assigned to a combination of specific two or more edges, a combination of three or more nodes, or a combination of two nodes not in a series; a directed graph modification unit for duplicating, among nodes included in a target path that includes all nodes or edges included in the combination, a node for which there is a path, other than the target path, that leads to the node and for modifying the directed graph so that a node for which the path leading to the node is included in the target path is distinguished from a node for which the path is not included in the target path; and an evaluation unit for evaluating, based on the weight, a path leading from a first node to a second node in the modified directed graph.

### BACKGROUND OF THE INVENTION

1. Field of the Invention

The present invention relates to data processing techniques and particularly to a data processing apparatus, method, and program for evaluating a path of a weighted directed graph.

2. Description of the Related Art

A program is widely used for converting a reading input by a user into a Kanji character in inputting a Japanese character string (for example, see patent document 1).

[Patent document 1] Japanese Laid-Open Publication No. 2004-139402

In order to improve the accuracy of converting the reading of text, which is input by a user, into text including Kanji characters, the inventor and others have developed a technique for selecting the best conversion candidate by: referring to a Kanji conversion dictionary; generating a directed graph constituted with a word including a Kanji character based on the reading of the input text; assigning scores to nodes of the directed graph, i.e., words, and to an edge between the nodes, i.e., the way the words are connected; and solving the optimal path problem of a weighted directed graph.

There is a strong need for a technique for more efficiently calculating the optimal path of a weighted directed graph in order to select a more accurate conversion candidate.

### SUMMARY OF THE INVENTION

In this background, a purpose of the present invention is to provide a technique for improving the user friendliness for data entry.

An embodiment of the present invention relates to a data processing apparatus. The data processing apparatus comprises: a first weight memory unit operative to store a weight assigned to a node or an edge between two nodes in a directed graph; a second weight memory unit operative, when a weight different from the weight stored in the first weight memory unit is assigned to at least one of nodes or edges included in a combination of specific two or more edges, a combination of three or more nodes, or a combination of two nodes not in a series, to store the weight assigned to a node or edge included in the combination; a directed graph modification unit operative to duplicate, among all nodes included in a target path that includes all nodes or edges included in the combination, a node for which there is a path, other than the target path, that leads to the node and to modify the directed graph so that a node for which the path leading to the node is included in the target path is distinguished from a node for which the path leading to the node is not included in the target path, when the combination is included in the directed graph; and an evaluation unit operative to evaluate a path leading from a first node to a second node in a directed graph modified by the directed graph modification unit based on the weights read out from the first weight memory unit and the second weight memory unit.

The directed graph modification unit may delete, for one of duplicated nodes, an edge not included in the target path among edges leading to the node and delete, for the other one of the duplicated nodes, an edge included in the target path among edges leading to the node.

A weight different from the weight stored in the first weight memory unit may be assigned to the last node of the target path.

The directed graph modification unit may duplicate a node included in a target path that includes all nodes or edges included in the combination and modify the directed graph so that a node for which the path leading to the node is included in the target path, a node for which the path leading to the node is included in the target path but the path leading from the node is not included in the target path, and a node for which the path leading to the node is not included in the target path are distinguished from one another.

The directed graph modification unit may duplicate a node included in a target path that includes all nodes or edges included in the combination and modify the directed graph so that a node for which the path leading from the node is included in the target path, a node for which the path leading from the node is included in the target path but the path leading to the node is not included in the target path, and a node for which the path leading from the node is not included in the target path are distinguished from one another.

Another embodiment of the present invention relates to a data processing method. The data processing method comprises: acquiring a directed graph; assigning a weight to a node or an edge between two nodes in the directed graph; determining, when a weight different from the weight assigned in assigning the weight to the node or the edge between the two nodes in the directed graph is assigned to at least one of nodes or edges included in a combination of specific two or more edges, a combination of three or more nodes, or a combination of two nodes not in a series, whether or not the combination is included in the directed graph; duplicating, among all nodes included in a target path that includes all nodes or edges included in the combination, a node for which there is a path, other than the target path, that leads to the node and modifying the directed graph so that a node for which the path leading to the node is included in the target path is distinguished from a node for which the path leading to the node is not included in the target path, when the combination is included in the directed graph; and evaluating based on the weight a path leading from a first node to a second node in a directed graph to which a path is added.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing an example of a directed graph;

FIG. 2 is a diagram showing weights assigned to nodes and edges of the directed graph shown in FIG. 1;

FIG. 3 is a diagram for explaining a method for solving the optimal path of a weighted directed graph shown in FIG. 2 by Viterbi algorithm;

FIG. 4 is a diagram showing an example of a directed graph generated in consideration that an exceptional weight is assigned to a combination of three nodes in a series;

FIG. 5 is a diagram showing an example of a directed graph generated in consideration that an exceptional weight is assigned to a combination of four nodes in a series;

FIG. 6 is a diagram showing a directed graph for obtaining the optimal path by Viterbi algorithm when an exceptional weight is assigned to a combination of three nodes in a series in the directed graph shown in FIG. 1;

FIG. 7 is a diagram showing weights assigned to each edge and node of the directed graph shown in FIG. 6 and the optimal path obtained by Viterbi algorithm;

FIG. 8 is a diagram showing a directed graph considering an exceptional weight assigned to a combination of two edges;

FIG. 9 is a diagram showing a directed graph considering an exceptional weight assigned to a combination of two nodes not in a series;

FIG. 10 is a diagram showing an example of a directed graph;

FIG. 11 is a diagram showing an example of a directed graph modified by the algorithm according to the embodiment;

FIG. 12 is a diagram showing an example of a directed graph modified by the algorithm according to the embodiment;

FIG. 13 is a diagram showing an example of a directed graph modified by the algorithm according to the embodiment;

FIG. 14 is a diagram showing the configuration of the data input apparatus according to the embodiment;

FIG. 15 is a diagram showing an example of a directed graph generated by a directed graph generation unit;

FIG. 16 is a diagram showing an example of internal data in a first weight memory unit;

FIG. 17 is a diagram showing an example of internal data in a second weight memory unit; and

FIG. 18 is a diagram showing an example of internal data in a directed graph memory unit.

### DETAILED DESCRIPTION OF THE INVENTION

The invention will now be described by reference to the preferred embodiments. This does not intend to limit the scope of the present invention, but to exemplify the invention.

The optimal path problem of a weighted directed graph where weights are assigned to the nodes or the edges between two nodes has an important technical meaning in many fields such as transfer guide for vehicles, workflow management, and natural language processing. Algorithms for solving the optimal path problem of a weighted directed graph includes Viterbi algorithm.

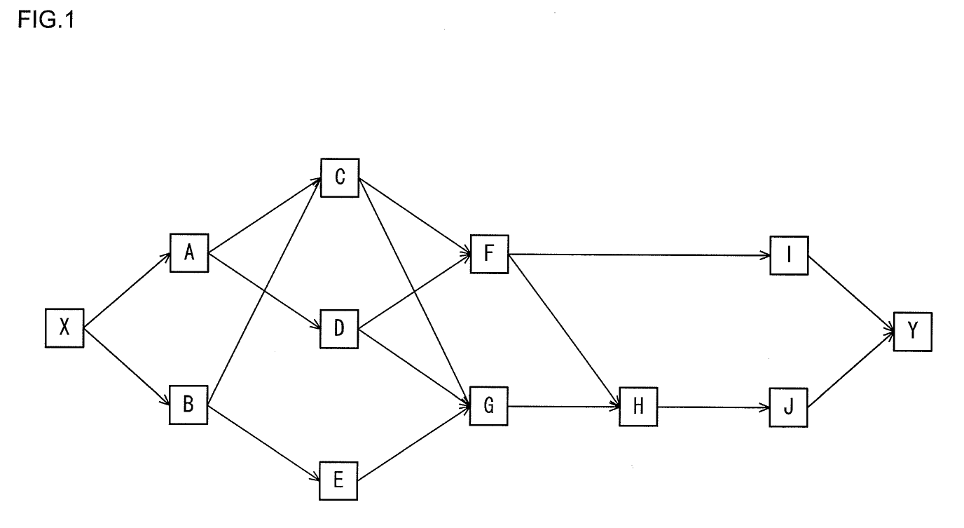

FIG. 1 shows an example of a directed graph. In order to hereinafter provide a simple explanation, it is assumed that the directed graph shown in FIG. 1 shows a path of a train travelling from a first node X, which is a departing station, to a second node Y, which is an arriving station, and that nodes A through J show connecting stations.

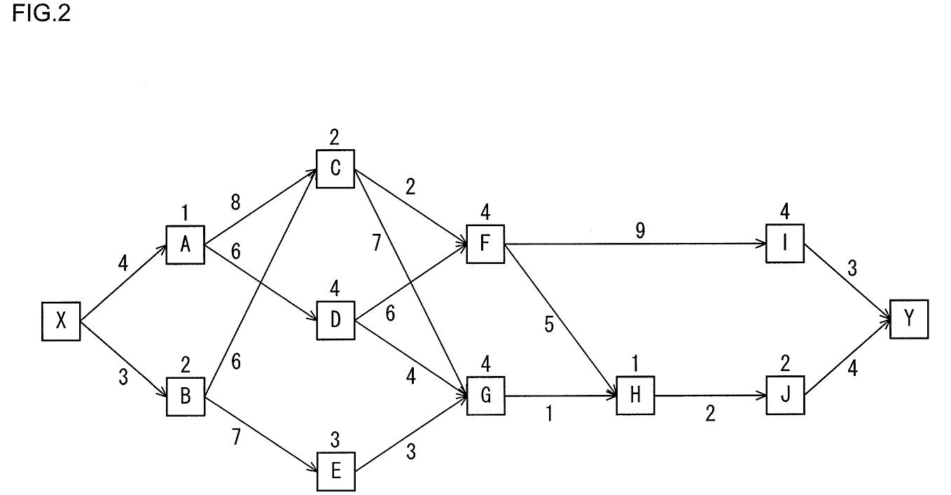

FIG. 2 shows weights assigned to nodes and edges of the directed graph shown in FIG. 1. In this example, the travel time between stations is assigned as a weight of each edge, and the time required for connection at a connecting station is assigned as a weight of each node. A method of determining the shortest path that requires the shortest travel time among paths from the departing station X to the arriving station Y.

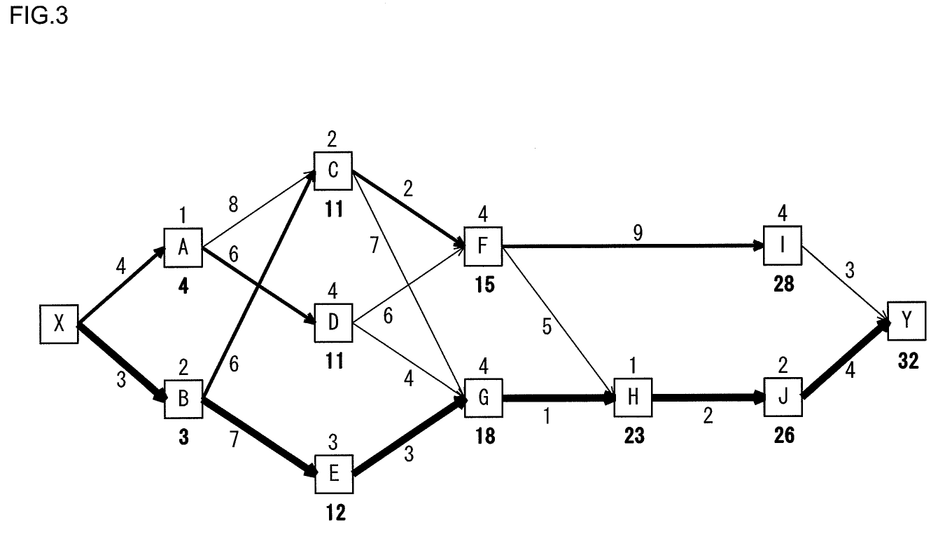

FIG. 3 is a diagram for explaining a method for solving the optimal path of a weighted directed graph shown in FIG. 2 by Viterbi algorithm; The shortest path from a departing station to each of connecting stations is obtained in stages starting from a node close to the departing station.

There is only one path from X station, which is a departing station, to A station. Thus, the shortest path from X station to A station is determined. The travel time from X station to A station through the shortest path is “4” minutes. Similarly, there is only one path from X station to B station. Thus, the shortest path from X station to B station is determined, and the travel time thereof is “3” minutes.

The shortest path from X station to C station is now computed. There are two edges A-C and B-C to C station as a final destination. The shortest travel time from X station to C station via A station is obtained to be “13” minutes by adding “4” minutes for the shortest travel time from X station to A station, “1” minute for a connecting time at A station, and “8” minutes for the travel time from A station to C station. Similarly, the shortest travel time from X station to C station via B station is obtained to be “11” minutes by adding “3” minutes for the shortest travel time from X station to B station, “2” minutes for a connecting time at B station, and “6” minutes for the travel time from B station to C station. Therefore, the shortest path from X station to C station goes through B station, and the travel time thereof is “11” minutes.

There is only one edge to D station as a final destination. Therefore, the shortest path from X station to D station goes through A station, and the travel time thereof is “11” minutes. Similarly, the shortest path from X station to E station goes through B station, and the travel time thereof is “12” minutes.

As described above, the shortest path to a given station is obtained by selecting, among one or more edges having the node thereof as their final destination, an edge with the shortest travel time, which is obtained by adding the shortest travel time to the station at the origin of the edge, the connecting time at the station at the origin of the edge, and the travel time from the station at the origin of the edge to the given station.

In a similar manner, the shortest paths and the shortest travel times can be obtained for all the stations to the arriving station Y. The last station before Y station is found to be J station when the edge with the shortest path is obtained among edges having the arriving station Y as a final destination. The shortest path is found by tracking back the last stations in such an order of J station to H station to G station to E station to B station to X station.

A method such as the one described above allows the amount of calculation to be dramatically reduced compared to a method where travel times are computed for all the paths from X station to Y station so as to determine the shortest path. Particularly in the field of natural language processing such as Kanji conversion and morphological analysis, the number of word candidates that constitute text, i.e., the number of nodes, becomes huge as the length of the text becomes longer. Thus, the reduction is necessary in the amount of calculation by employing such a method.

Viterbi algorithm is based on the premise that the optimal path to a given node can be determined independently from the optimal path to the last node before the given node. In other words, the optimal path to a given node can be applied when the optimal path is determined based on the immediate optimal result without going back into the past.

However, in reality, an exceptional condition is sometimes set for a certain combination of edges or nodes. For example, it is assumed that there is a condition where an express train runs for a route from D station to H station via G station and where the travel time from D station to H station via G station is shorter than just the total of the travel time from D station to G station and the travel time from G station to H station. Such an exceptional condition cannot be expressed in the weighted directed graph shown in FIG. 2.

As described above, when not only a weight of a node or edge is assigned to a combination of two nodes in a series but also an exceptional weight is assigned to a combination of three or more nodes, a path that passes through the combination is required to be provided separately in order to set exceptional weights to the combination.

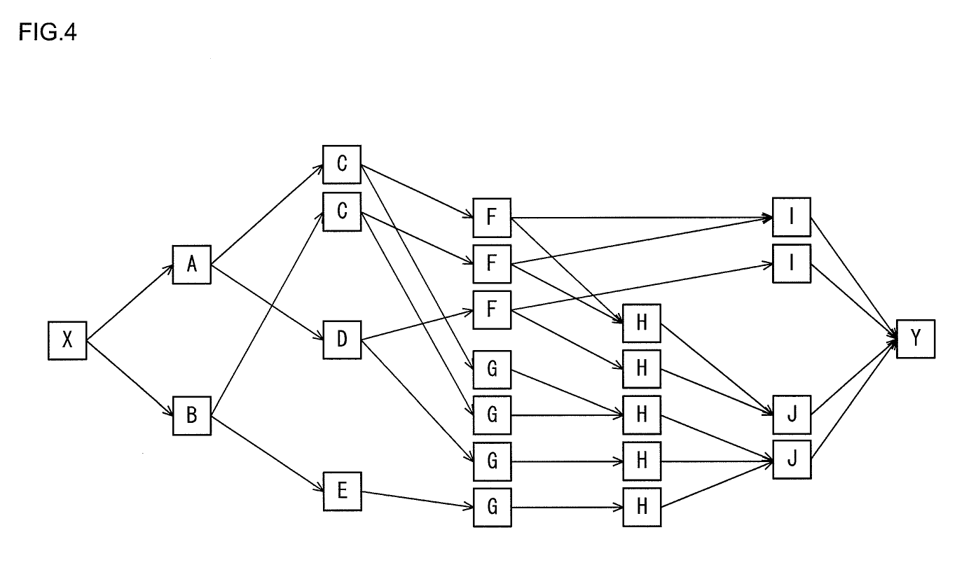

FIG. 4 shows an example of a directed graph generated in consideration that an exceptional weight is assigned to a combination of three nodes in a series. In the directed graph in FIG. 2, for example, a path A-C-F and a path B-C-F are not distinguished from each other as a path leading to F. This is because whether the path goes through A or B is not taken into consideration when the shortest path to F is determined due to the assumption that the shortest path is taken to C. On the other hand, two nodes each are provided for C and F so that a path A-C-F and a path B-C-F are expressed as different paths in the directed graph in FIG. 4. This allows a path to F via A and C and a path to F via B and C to be distinguished from each other, and different weights can be thus assigned. Similarly, multiple nodes are provided also for other nodes so that paths different in their second last nodes are distinguished from each other.

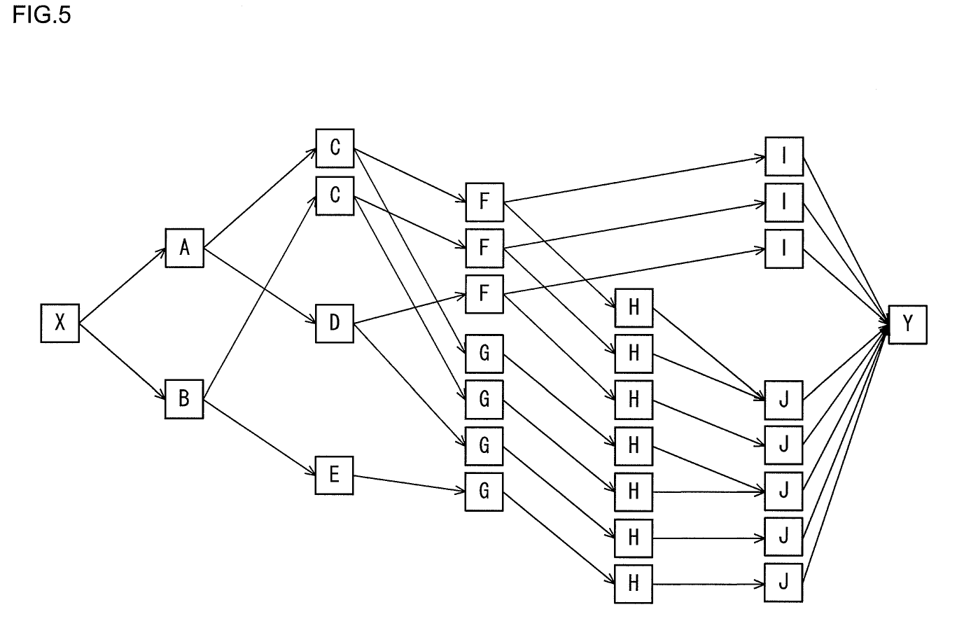

FIG. 5 shows an example of a directed graph generated in consideration that an exceptional weight is assigned to a combination of four nodes in a series. A path A-C-F-H and a path B-C-F-H are not distinguished from each other in the directed graph in FIG. 4. However, since paths different in their third last nodes are distinguished from each other in the directed graph in FIG. 5, a node H is provided for a path A-C-F-H and another node H is provided for a path B-C-F-H.

In the directed graphs shown in FIG. 4 and FIG. 5, the optimal path can be obtained in consideration of an exceptional weight assigned to a combination of three or more nodes in a series. However, a directed graph cannot be generated when the number of nodes in a series is not known that are included in a combination to which an exceptional weight is assigned. For example, taking a combination of three nodes in a series into consideration, the directed graph shown in FIG. 5 needs to be generated. When an exceptional weight is newly assigned to a combination of four nodes in a series, the directed graph shown in FIG. 5 needs to be regenerated.

When the size of an original directed graph is large, for example, for the application to natural language processing, there is a possibility that the number of paths to be added become so large that the amount of calculation dramatically increases, reducing the speed of calculation.

The embodiment provides a technique for efficiently obtaining the optimal path when an exceptional weight is assigned to a combination of two or more edges, a combination of three or more nodes, and a combination of two nodes not in a series in a weighted directed graph.

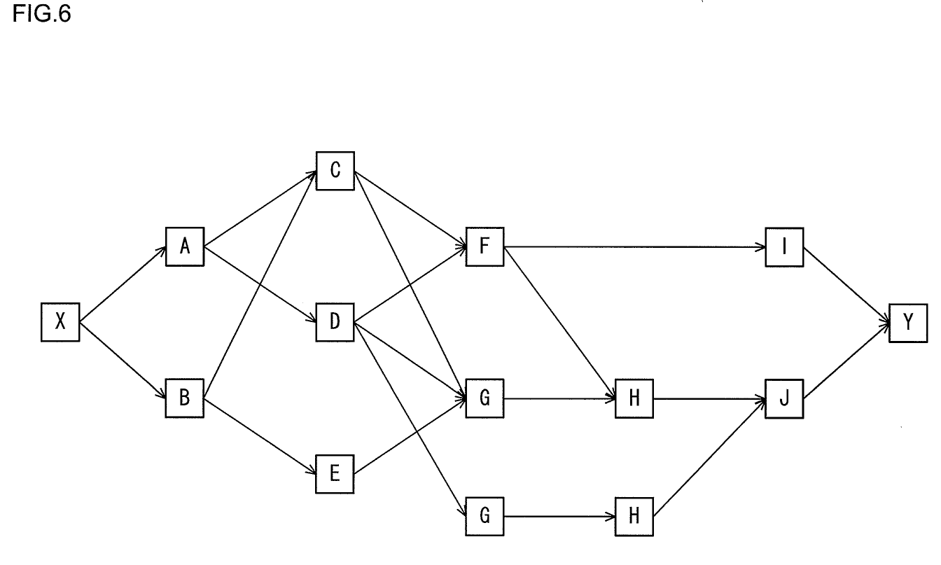

FIG. 6 shows a directed graph for obtaining the optimal path by Viterbi algorithm when an exceptional weight is assigned to a combination of three nodes in a series in the directed graph shown in FIG. 1. In FIG. 6, in order to assign an exceptional weight to a combination of three nodes D-G-H in a series, another path D-G-H is added to the directed graph. More specifically, a path branching from the first node D of a combination of D-G-H to the last node H via a node G in the middle is duplicated.

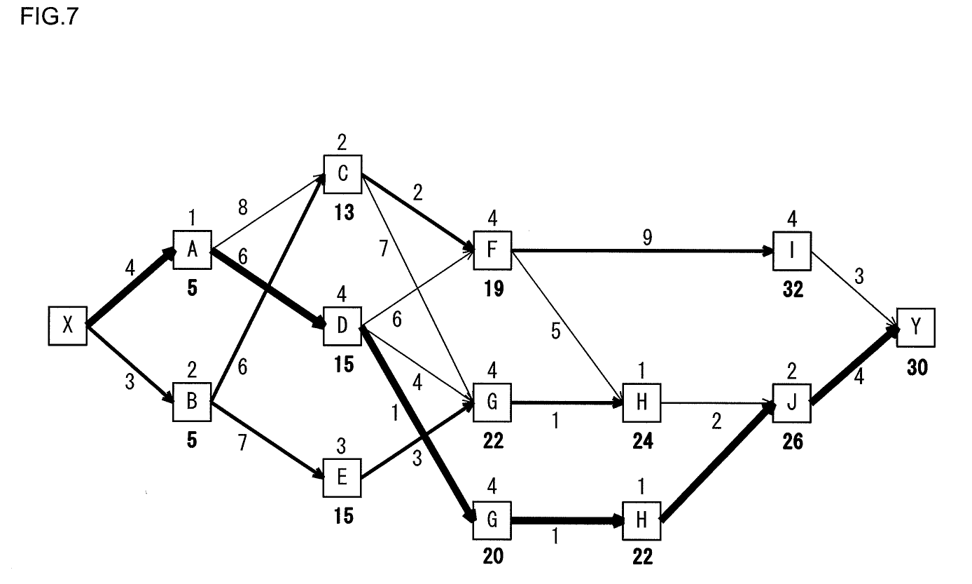

FIG. 7 shows both weights assigned to each edge and node of the directed graph shown in FIG. 6 and the optimal path obtained by Viterbi algorithm. FIG. 7 shows an example where the travel time between D station and G station is reduced from four minutes to one minute when a path D station-G station-H station is passed through since an express train runs for the path D station-G station-H station. Among two nodes H in the figure, the upper node H shows the result of obtaining the optimal path to the node H without taking an exceptional weight into consideration, and the lower node H shows the result of obtaining the optimal path to the node H while taking into consideration an exceptional weight assigned to the path D-G-H.

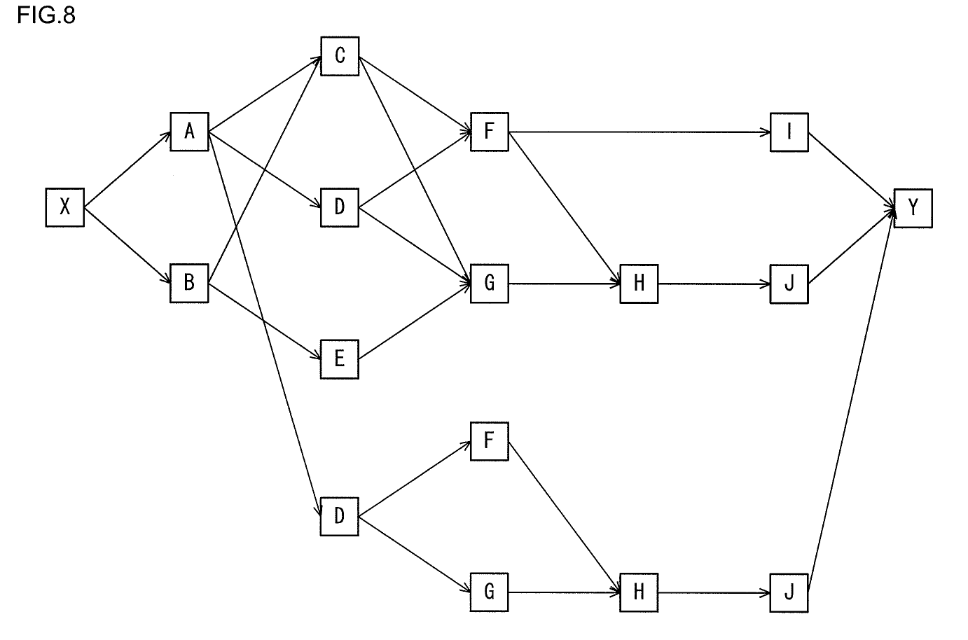

FIG. 8 shows a directed graph considering an exceptional weight assigned to a combination of two edges. In FIG. 8, an exceptional weight is assigned to a combination of an edge A-D and an edge H-J. For example, a route from A station to D station and a route from H station to J station are operated by the same subject, and such an example is thus expected where a discount fare is applied when taking these routes. In this case, a path including an edge A-D and an edge H-J is extracted from the original directed graph, and the extracted path is added to the directed graph. This allows both a path that passes through both an edge A-D and an edge A-J to be newly provided in the directed graph and an exceptional weight to be assigned to the path.

FIG. 9 shows a directed graph considering an exceptional weight assigned to a combination of two nodes not in a series. In FIG. 9, an exceptional weight is assigned to a combination of a node D and a node H. For example, when converting text input in Hiragana characters into text including a mixture of Kanji characters and Japanese phonetic characters, an example of co-employment can be expected such that the score of a candidate for a word “to fly” shown in a mixture of Kanji and Japanese phonetic characters increases as a conversion candidate for a word “to fly” input in Hiragana characters when the preceding word is a “bird.” In this case, a path between the node D and the node H is extracted from the original directed graph, and the extracted path is added to the directed graph. This allows the score of the node H without taking into consideration the existence of the node D and the score of the node H when the node D precedes the node H to be expressed in distinction from each other.

In this manner, by adding a path assigned an exceptional weight, the increase of the amount of calculation is suppressed to be minimal, and the optimal path can be obtained also in consideration of an exceptional condition where not the last node but previous nodes need to be tracked back and referred to.

In the above example, a path assigned an exceptional weight is added to a directed graph. In this case, there are substantially the same paths in the directed graph in a redundant manner. This is not considered a problem in searching the optimal path. However, since substantially the same path can be reported as a different path in computing a second or later path, there is a possibility that N-best search algorithm fails. Therefore, it is necessary, in performing an N-best search, to modify paths without changing the total number of the paths even when a node or edge is added. A further explanation is given of such an algorithm.

In modifying a directed graph, a programming language, etc., based on predicate logic may be used. In this case, an exceptional weight is assigned as a condition request for a node. The condition request is provided in a procedural (predicate) manner where a truth value or another predicate is returned by using a node as an argument.

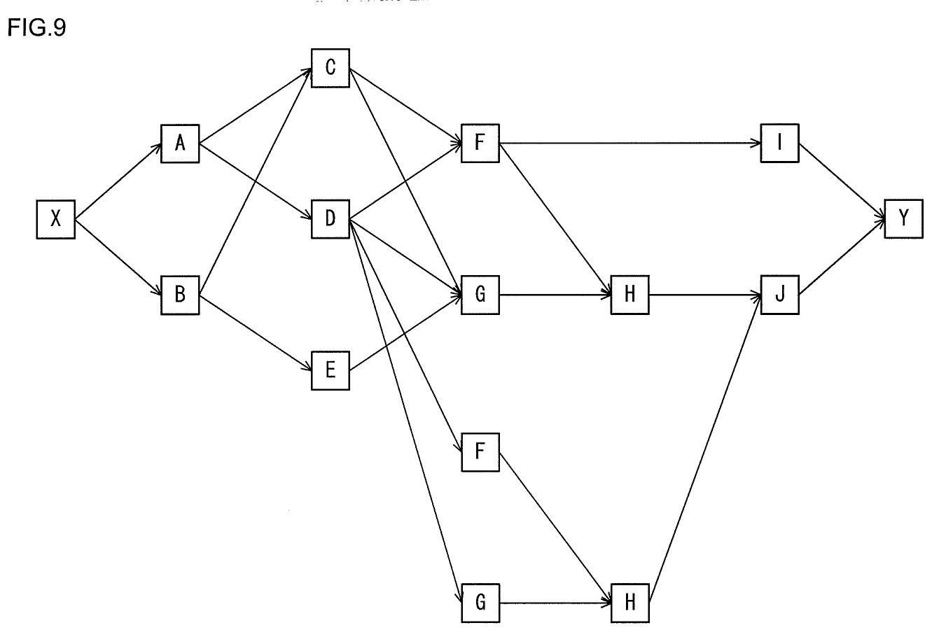

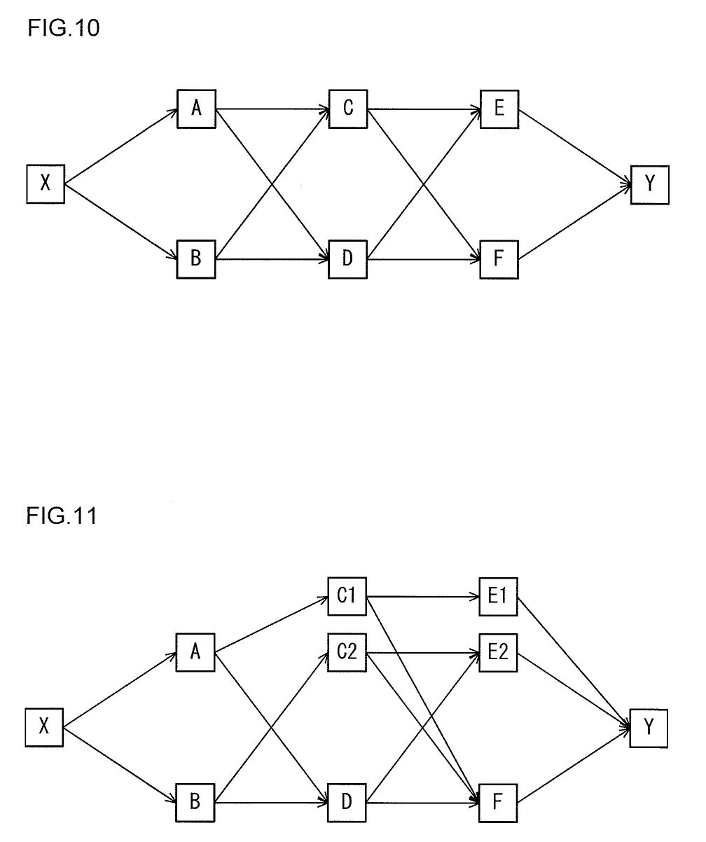

For example, it is assumed that an exceptional weight is assigned to a combination of three nodes “A-C-E” in a series in the weighted directed graph shown in FIG. 10. In order to ‘detect a node sequence “A-C-E,”’ a condition request is provided to determine ‘whether nodes are arranged in the order “A-C-E.”’ The condition request is not satisfied for nodes other than a node E. Thus, the nodes other than the node E return false in response to the condition request. The node E returns another predicate indicating ‘whether the preceding nodes are arranged in the order “A-C”’ in response to the condition request. Since a node D preceding the node E does not satisfy the condition request, it returns false. The node C satisfies the condition request and returns a predicate indicating ‘whether the preceding node is arranged in the order “A”’ in response to the condition request. Among nodes preceding the node C, a node A satisfies the condition request; however a node B does not satisfy the condition request.

The node C that satisfies the condition request returned by the node E is duplicated, and the node C that satisfies the condition request of the predicate returned by the node C and the node C that does not satisfy the condition request are distinguished from each other. In other words, the node C (C1) preceded by the node “A” and the node C (C2) not preceded by the node “A” are distinguished from each other. Among edges leading to the node C1, an edge “B-C1” not preceded by the node “A” is deleted for the node C1. An edge “A-C2” preceded by the node “A” is deleted for the node C2. Furthermore, the node E (E1) preceded by an edge “A-C” and the node E (E2) not preceded by the edge “A-C” are distinguished from each other in a similar manner. An edge “D-E1” not preceded by the edge “A-C” is deleted for the node E1 in this case. With regard to the node E2, no edges is deleted since neither an edge “C2-E” nor an edge “D-E” is preceded by the edge “A-C.” A directed graph modified in this manner is shown in FIG. 11.

Such an algorithm allows the node E preceded by the edge “A-C” and the node E not preceded by the edge “A-C” to be distinguished from each other so that different weights are assigned, without changing the total number of paths. In this case, an exceptional weight that is assigned to the combination of three nodes “A-C-E” in a series is assigned as the weight of the node “E2,” which is the last node of the combination.

Such an algorithm allows for appropriate modification of a directed graph even when an exceptional weight is assigned to a combination of nodes “A-?-E” (note that ? is one arbitrary node). In this case, the node E needs to return a predicate indicating ‘whether the preceding node is arranged in the order “A-?”’ in response to the condition request indicating ‘whether nodes are arranged in the order “A-?-E.”’ In response to this condition request, an arbitrary node preceding the node E needs to return a predicate indicating ‘whether the preceding node is arranged in the order “A.”’

When an exceptional weight is assigned to a combination of nodes “A-*-E” (note that * is one arbitrary node), the node E needs to return a predicate indicating ‘whether the preceding node is arranged in the order “A-*”’ in response to the condition request indicating ‘whether nodes are arranged in the order “A-*-E.”’ In response to this condition request, an arbitrary node, other than the node “A,” needs to return again the predicate indicating ‘whether the preceding node is arranged in the order “A-*.”’ Such a condition request where a wild card is used produces an unlimited combination length as a result. Thus, such a condition request is not used in a conventional method where a fixed length limit is set at the beginning. However, it can be properly used according to the embodiment.

In the above example, nodes are distinguished from one another according to whether or not their preceding paths satisfy a condition. Furthermore, nodes may be distinguished from one another according to whether or not their subsequent paths satisfy a condition. In other words, in the case of analyzing a path in a forward direction, nodes are separated into three types of nodes: (1) a node whose preceding path and subsequent path satisfy a condition; (2) a node whose preceding path satisfies a condition but whose subsequent path does not satisfy a condition; (3) a node whose preceding path does not satisfy a condition. In the case of analyzing a path in a reverse direction, nodes are separated into three types of nodes: (1) a node whose subsequent path and preceding path satisfy a condition; (2) a node whose subsequent path satisfies a condition but whose preceding path does not satisfy a condition; (3) a node whose subsequent path does not satisfy a condition.

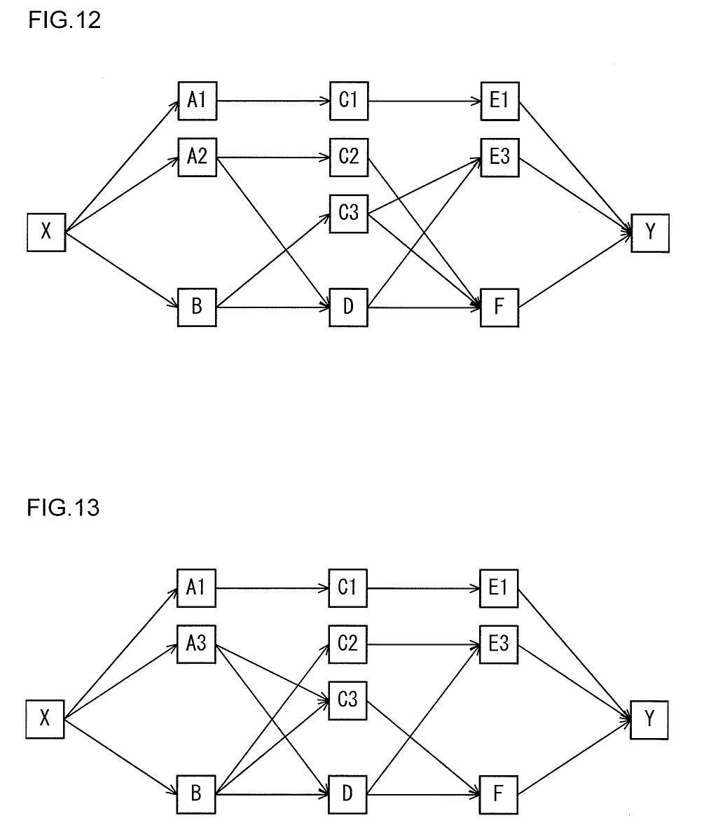

For example, in the same manner as the above example, a case is taken into consideration where an exceptional weight is assigned to a combination of three nodes “A-C-E” in a series in the directed graph shown in FIG. 10. When the directed graph is analyzed in a forward direction from the beginning, a node A (A1) whose subsequent path includes an edge C-E is distinguished from a node A (A2) whose subsequent path does not include the edge C-E. Furthermore, a node C (C1) preceded by the node A and followed by a node E, a node C (C2) preceded by the node A but not followed by the node E, and a node C (C3) not preceded by the node A are distinguished from one another. Furthermore, the node E (E1) preceded by the edge “A-C” and the node E (E3) not preceded by the edge “A-C” are distinguished from each other. A directed graph modified in this manner is shown in FIG. 12. Similarly, a directed graph modified by analyzing the directed graph in a reverse direction from the end is shown in FIG. 13.

Such an algorithm allows a path “A-C-E” to be separated from other paths so that different weights are assigned, without changing the total number of paths. In this case, an exceptional weight that is assigned to the combination of three nodes “A-C-E” in a series may be assigned to an arbitrary node or edge included in the combination.

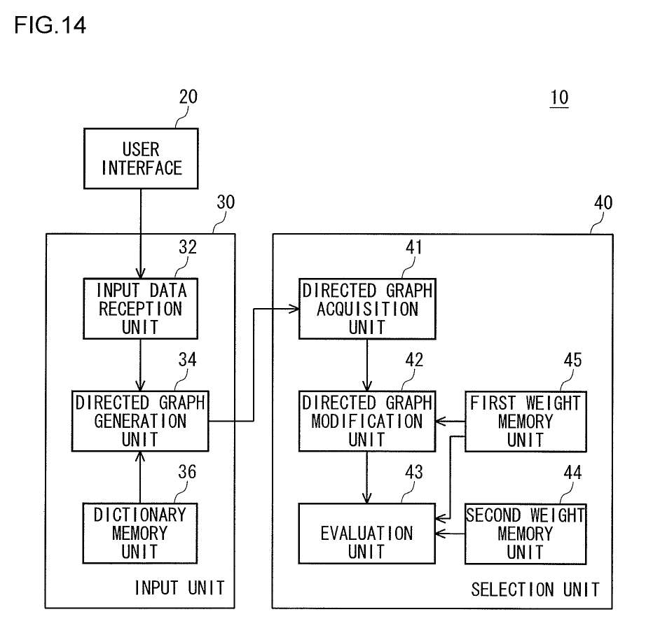

FIG. 14 shows the configuration of a data analyzing apparatus 10 according to the embodiment. The data analyzing apparatus 10 performs morphological analysis on English text to be analyzed. The data analyzing apparatus 10 is provide with a user interface 20, an input unit 30, and a selection unit 40, which is an example of data processing apparatuses. The input unit 30 includes an input data reception unit 32, a directed graph generation unit 34, and a dictionary memory unit 36. The selection unit 40 includes a directed graph acquisition unit 41, a directed graph modification unit 42, an evaluation unit 43, a first weight memory unit 44, a second weight memory unit 45, and a directed graph memory unit 46. These configurations are implemented in hardware component by any CPU of a computer, a memory or a program loaded into the memory. Functional blocks are implemented by the cooperation of hardware components. Thus, a person skilled in the art should appreciate that there are many ways of accomplishing these functional blocks in various forms in accordance with the components of hardware only, software only, or the combination of both.

The input data reception unit 32 receives text data input by a user via the user interface 20. The input data reception unit 32 may acquire text to be analyzed from, for example, other apparatuses or storage media. The directed graph generation unit 34 generates a directed graph having a part of speech of each word as a node from text data received by the input data reception unit 32 in reference to dictionary data stored in the dictionary memory unit 36. The dictionary memory unit 36 stores a dictionary storing spellings of words, parts of speech, the probability of occurrence of the words in each part of speech, and the like in association with one another.

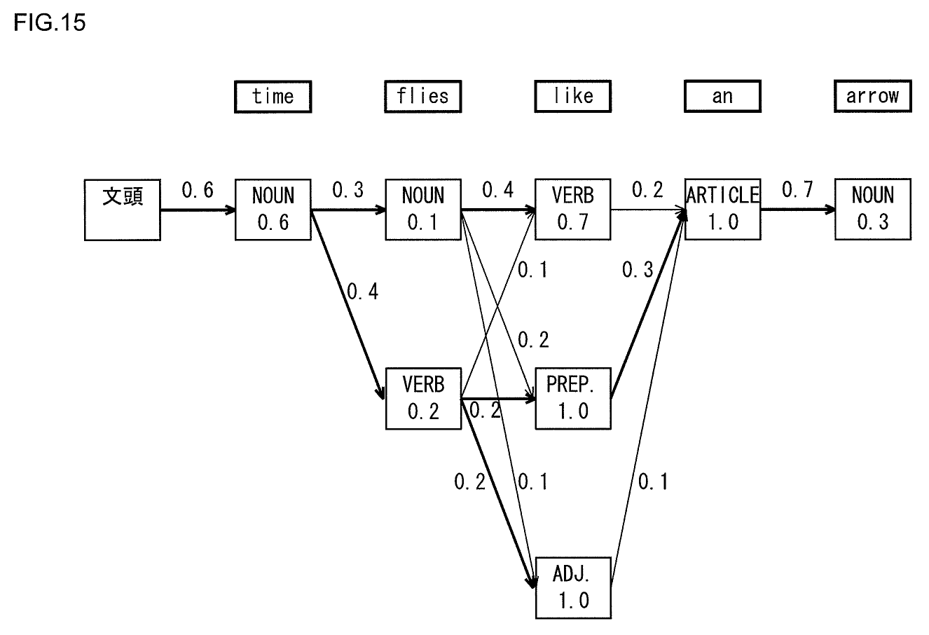

FIG. 15 shows an example of a directed graph generated by the directed graph generation unit 34. FIG. 15 shows an example of a directed graph generated when text “time flies like an arrow” is input. At the positions of words, the possible outputting states (the part of speech) of the words are arranged as nodes in a vertical direction, and a directed graph is generated by connecting the nodes with arrows showing state transitions.

The directed graph generation unit 34 searches a dictionary starting from the first word of the input text, acquires the parts of speech of the words registered in the dictionary, and generates nodes for respective parts of speech. In this example, a “noun” is registered for the word “time” as the part of speech. Thus, a node corresponding to the part of speech is generated. Two parts of speech “noun” and “verb” are registered for the subsequent word “flies.” Thus, two nodes corresponding to the respective parts of speech are generated. In this manner, the words are extracted starting from the beginning, and nodes are generated.

In FIG. 15, the output probabilities of words of the parts of speech are shown as the weights of nodes in the rectangles of the respective nodes, and the state transition probabilities between parts of speech are shown as the weights of edges near the respective edges. Scores based on the use frequencies of the words in general text may be used as the weights of the nodes. The scores of words used by a user may be increased so that the conversion history of the user is incorporated. Scores based on the use frequencies of the connections of the words in general text may be used as the weights of the edges. Scores may be provided based on the properness of how parts of speech are connected with one another in general text.

Once a directed graph is generated, the optimal combination of parts of speech can be selected by solving the previously-mentioned optimal path problem. In FIG. 15, transitions with the highest probabilities are shown by heavy lines among the transitions leading to the respective states at the positions of the respective words. The optimal state transition series for the whole sentence can be obtained by tracking back the heavy lines in a reverse direction from the word at the end of the sentence. The optimal state transition series can be similarly calculated in this way, for example, even when there is an article, an adjective, or the like in the middle of the sentence. In order to hereinafter provide a simple explanation, the previously-mentioned directed graph showing a path of a train is referred back.

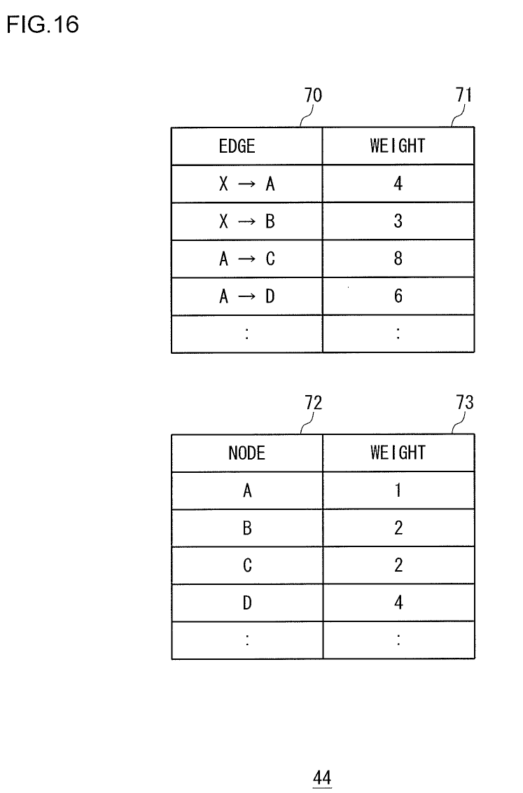

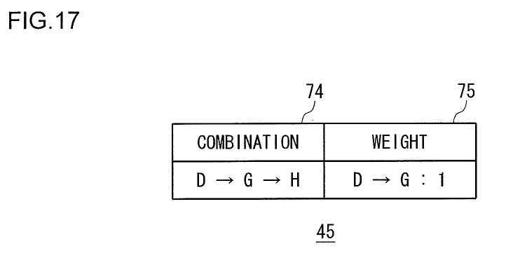

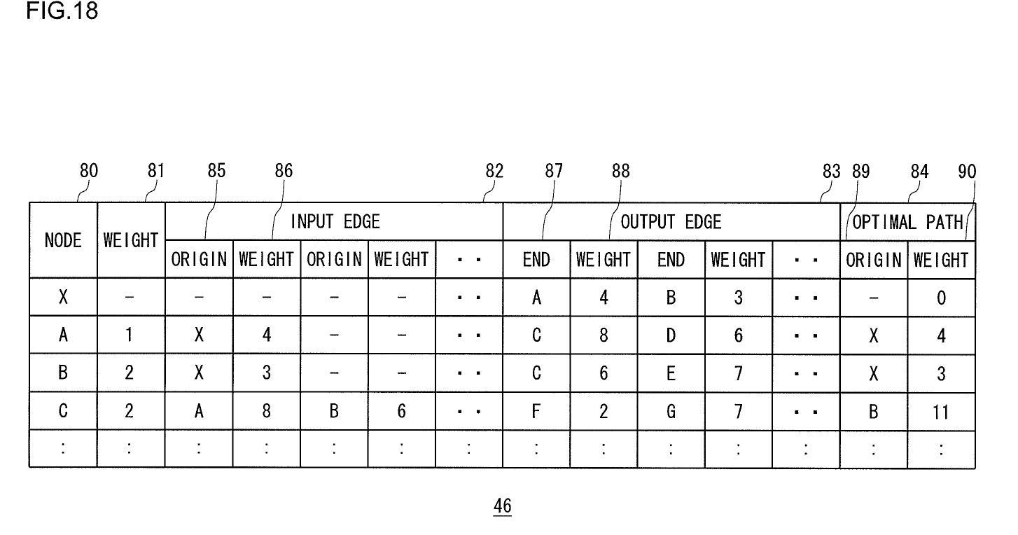

The first weight memory unit 44 stores a weight assigned to a node or an edge between two nodes in a directed graph. FIG. 16 shows an example of internal data in the first weight memory unit 44. The first weight memory unit 44 is provided with an edge column 70, a weight column 71, a node column 72, and a weight column 73 and stores both the weight assigned to an edge and the weight assigned to a node. The weight of a node or an edge may be provided when a directed graph is generated. In this case, the weight of a node or an edge may be stored in the dictionary memory unit 36 or the like.

When a weight, which is different from the weight computed from the weight assigned to a node or edge stored in the first weight memory unit 44, is assigned to a combination of two or more edges, a combination of three or more nodes, or a combination of two nodes not in a series, the second weight memory unit 45 stores the weight assigned to the combination. FIG. 27 shows an example of internal data in the first weight memory unit 45. The second weight memory unit 45 is provided with a combination column 74 and a weight column 75 and stores a weight exceptionally assigned to a combination of nodes or edges.

The directed graph acquisition unit 41 acquires a directed graph generated by the directed graph generation unit 34. The directed graph memory unit 46 stores the directed graph acquired by the directed graph acquisition unit 41. FIG. 18 shows an example of internal data in the directed graph memory unit 46. The directed graph memory unit 46 is provided with a node column 80, a weight column 81, an input edge column 82, an output edge column 83, and an optimal path column 84. The node column stores information identifying a node constituting a directed graph. The weight column 81 stores a weight assigned to a node. The input edge column 82 includes multiple groups of origin columns 85 and weight columns 86 and stores both the origins of edges ending at the corresponding nodes and the weights of the edges. The output edge column 83 includes multiple end columns 87 and weight columns 88 and stores both the ends of edges originating from the corresponding nodes and the weights of the edges. As previously described, the weights of corresponding nodes or edges when the directed graph generation unit 34 generates a directed graph may be stored in the respective weight columns, or the directed graph acquisition unit 41 may store the weights of corresponding nodes or edges in reference to the first weight memory unit 44 when it acquires a directed graph from the directed graph generation unit 34 and stores the directed graph in the directed graph memory unit 46. The optimal path column 84 includes an origin column 89 and a weight column 90 and stores both the immediately preceding node in the optimal path leading to the corresponding node selected by the evaluation unit 43 and the weight of the optimal path leading to the corresponding node.

When a directed graph stored in the directed graph memory unit 46 includes a combination of nodes or edges for which an exceptional weight is stored in the second weight memory unit 45, the directed graph modification unit 42 modifies the directed graph so that a path going through the nodes or edges included in the combination is distinguished from other paths. The algorithm for modifying the directed graph is as described above.

The evaluation unit 43 evaluates a path leading from a first node to a second node in a directed graph to which a path is added by the directed graph modification unit 42 based on the weights read out from the first weight memory unit 44 and the second weight memory unit 45. The evaluation unit 43 selects the optimal path among multiple paths leading from the first node to the second node based on the weight.

As explained in FIG. 3, with regard to nodes included in a path from a first node to a second node, the evaluation unit 43 selects the optimal path from the first node to the second node based on Viterbi algorithm by selecting the optimal path from the first node to each of the nodes starting from the node near the first node according to weights.

When selecting the optimal path from the first node to a given node, the evaluation unit 43 selects, among one or more edges ending at the node, an edge providing the optimal path from the first node to the node based on both the weights assigned to the edges and the weights of the optimal paths from the first node to the originating nodes of the edges. Based on both the weight of the optimal path from the first node to the originating node of a selected edge and the weight assigned to the selected edge or the given node, the weight of the optimal path from the first node to the given node is computed. The weight of a path may be, for example, the addition of the weights assigned to edges and nodes included in the path. The weight may be computed by other arithmetic expressions.

The method of the embodiment allows for flexible setting of a condition since a combination of edges or nodes assigned an exceptional weight can be added to a directed graph even after the directed graph is generated. Even when an exceptional condition is provided, the optimal path can be obtained by Viterbi algorithm. Thus, the amount of calculation and the time required for calculation can be reduced to a large extent. The modification of a path may be performed while the directed graph generation unit 34 generates a direct graph, or it may be performed while the evaluation unit 43 evaluates the weight of a path.

Described above is an explanation based on the embodiments of the present invention. These embodiments are intended to be illustrative only, and it will be obvious to those skilled in the art that various modifications to constituting elements and processes could be developed and that such modifications are also within the scope of the present invention.

What is claimed is:

1. A data processing apparatus comprising:
a first weight memory unit operative to store a weight assigned to a node or an edge between two nodes in a directed graph;
a second weight memory unit operative, when a weight different from the weight stored in the first weight memory unit is assigned to at least one of nodes or edges included in a combination of specific two or more edges, a combination of three or more nodes, or a combination of two nodes not in a series, to store the weight assigned to a node or edge included in the combination;
a directed graph modification unit operative to duplicate, among all nodes included in a target path that includes all nodes or edges included in the combination, a node for which there is a path, other than the target path, that leads to the node and to modify the directed graph so that a node for which the path leading to the node is included in the target path is distinguished from a node for which the path leading to the node is not included in the target path, when the combination is included in the directed graph; and
an evaluation unit operative to evaluate a path leading from a first node to a second node in a directed graph modified by the directed graph modification unit based on the weights read out from the first weight memory unit and the second weight memory unit.

2. The data processing apparatus according to claim 1 wherein the directed graph modification unit deletes, for one of duplicated nodes, an edge not included in the target path among edges leading to the node and deletes, for the other one of the duplicated nodes, an edge included in the target path among edges leading to the node.

3. The data processing apparatus according to claim 1 wherein a weight different from the weight stored in the first weight memory unit is assigned to the last node of the target path.

4. The data processing apparatus according to claim 1 wherein the directed graph modification unit duplicates a node included in a target path that includes all nodes or edges included in the combination and modifies the directed graph so that a node for which the path leading to the node is included in the target path, a node for which the path leading to the node is included in the target path but the path leading from the node is not included in the target path, and a node for which the path leading to the node is not included in the target path are distinguished from one another.

5. The data processing apparatus according to claim 1 wherein the directed graph modification unit duplicates a node included in a target path that includes all nodes or edges included in the combination and modifies the directed graph so that a node for which the path leading from the node is included in the target path, a node for which the path leading from the node is included in the target path but the path leading to the node is not included in the target path, and a node for which the path leading from the node is not included in the target path are distinguished from one another.

6. A data processing method comprising:
acquiring a directed graph;
assigning a weight to a node or an edge between two nodes in the directed graph;
determining, when a weight different from the weight assigned in assigning the weight to the node or the edge between the two nodes in the directed graph is assigned to at least one of nodes or edges included in a combination of specific two or more edges, a combination of three or more nodes, or a combination of two nodes not in a series, whether or not the combination is included in the directed graph;
duplicating, among all nodes included in a target path that includes all nodes or edges included in the combination, a node for which there is a path, other than the target path, that leads to the node and modifying the directed graph so that a node for which the path leading to the node is included in the target path is distinguished from a node for which the path leading to the node is not included in the target path, when the combination is included in the directed graph; and
evaluating based on the weight a path leading from a first node to a second node in a directed graph to which a path is added.

7. A data processing program embedded in a computer readable medium, comprising:
a module operative to assign a weight to a node or an edge between two nodes in the directed graph;
a module operative to determine, when a weight different from the weight assigned in the module operative to assign the weight to the node or the edge between the two nodes in the directed graph is assigned to at least one of nodes or edges included in a combination of specific two or more edges, a combination of three or more nodes, or a combination of two nodes not in a series, whether or not the combination is included in the directed graph;
a module operative to duplicate, among all nodes included in a target path that includes all nodes or edges included in the combination, a node for which there is a path, other than the target path, that leads to the node and to modify the directed graph so that a node for which the path leading to the node is included in the target path is distinguished from a node for which the path leading to the node is not included in the target path, when the combination is included in the directed graph; and
a module operative to evaluate based on the weight a path leading from a first node to a second node in a directed graph to which a path is added.
